(19) United States
(12) Patent Application Publication
(10) Pub. No.: US 2009/0171718 A1
(43) Pub. Date: Jul. 2, 2009

(54) SYSTEM AND METHOD FOR PROVIDING WORKFORCE AND WORKLOAD MODELING

(75) Inventors: Lisa R. Barlow, Norwell, MA (US); James H. Drew, Sugar Hill, NH (US); Katherine T. Ross, Virginia Beach, VA (US); Paula Wehmeyer, Gorham, ME (US)

Correspondence Address: VERIZON;PATENT MANAGEMENT GROUP, 1320 North Court House Road, 9th Floor, ARLINGTON, VA, 22201-2909, US

(73) Assignees: Verizon Services Corp., Arlington, VA (US); Verizon Services Organization Inc., Irving, TX (US)

(21) Appl. No.: 11/968,315

(22) Filed: Jan. 2, 2008

(51) Int. Cl. G06F 17/00

(52) U.S. Cl. 705/7

(57) ABSTRACT

Workforce and workload prediction is provided. A portal is configured to receive input from a user, wherein the input relates to forecasting workload and workforce for providing a communication service. The workload includes ticket loads relating to repair and provisioning, and the workforce includes human resources and equipment. A load prediction is output in response to the input, wherein the load prediction is generated by a forecast model that utilizes regression analysis of historical data and real-time information that includes workforce availability data and one or more factors impacting the workload.

### BACKGROUND INFORMATION

Modern communication networks are increasing in size and complexity. However, many of these networks are built upon legacy point-to-point connections fixed across transmission mediums, such as twisted pair, fiber optic, coax, and the like. These physical facilities deteriorate with time and exposure to environmental conditions such as humidity, precipitation, solar radiation, temperature, etc. Hence, network service providers typically engage in maintenance and repair procedures in order to thwart network outages, as well as continually improving service to the customer. In fact, given the highly competitive nature of the telecommunications industry, service providers have relied on network availability as a key differentiator for delivering voice, data, and video services. In many instances, the impact of network failures, even if for a short duration, can result in substantial losses. Additionally, the capability to quickly provision service for a customer provides the service provider with a competitive edge. Consequently, the ability to rapidly and efficiently dispatch technicians to maintain and repair existing infrastructures, as well as provision new facilities/services is a critical business component for these service providers.

Therefore, there is a need for an approach that provides efficient workforce and workload modeling to facilitate workforce decision making.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of workforce and workload modeling, according to an exemplary embodiment;

FIG. 2 is a diagram of a force/load modeling system, according to an exemplary embodiment;

FIG. 3A is a flowchart of a process for forecasting a workload, according to an exemplary embodiment;

FIG. 3B is a flowchart of a process for providing a workload model, according to an exemplary embodiment;

FIG. 4 is a flowchart of a process for providing a hypothetical workload based on one or more hypothetical user input parameters, according to an exemplary embodiment;

FIGS. 5A and 5B are diagrams of user interfaces for workload and workforce modeling, according various exemplary embodiments; and

FIG. 6 is a diagram of a computer system that can be used to implement various exemplary embodiments.

### DESCRIPTION OF THE PREFERRED EMBODIMENTS

A preferred apparatus, method, and software for workforce and workload modeling are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement In other instances, well-known structures and devices are shown in block diagram form in order to avoid unnecessarily obscuring the preferred embodiments of the invention.

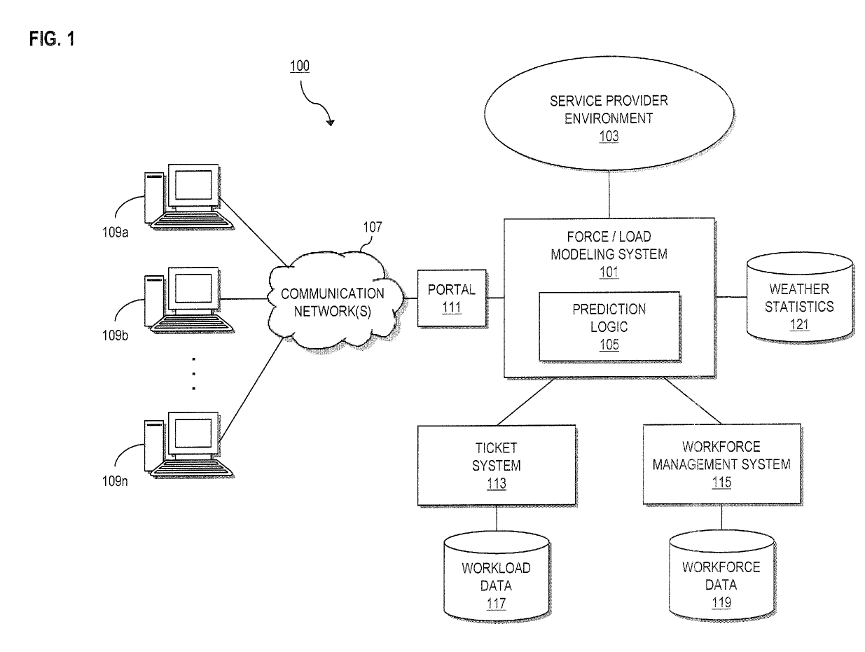

FIG. 1 is a diagram of a system capable of workforce and workload modeling, according to an exemplary embodiment. For the purposes of illustration, a system 100 is described with respect to a force/load modeling system (i.e., “modeling system”) 101 that is configured to dynamically forecast a workforce and a workload as the workforce and the workload relate to a service provider environment 103. By way of example, service provider environment 103 may correspond to the infrastructure of a network service provider in support of any type of service, e.g., a data, voice, and/or video. While specific reference will be made thereto, service provider environment 103 may correspond to any environment conducive to workforce/workload modeling, such as a product manufacturing environment, a professional staffing environment, a resource allocation environment, etc. As such, it is contemplated that system 100 may embody many forms and include multiple and/or alternative components and facilities.

It is noted that network service providers are invariably presented with various infrastructure issues related to repairing lost connections, maintaining existing facilities, and upgrading resources, not to mention continually attempting to provision new accounts and new services for their customers. This inevitably leads to an amount of both expected and unexpected work, i.e., a variable workload having a threshold baseline. As networks geographically expand and grow more technologically advanced, it is becoming a rather complex and onerous task to ensure and supply the right amount of technicians with the appropriate amount of resources (i.e., an enabled workforce) to meet workload demands. Given this prevalence, geographic dispersion, and continual expansion of modern networks, it is becoming evermore challenging for service providers to delicately balance pending and/or predicted jobs (i.e., workload) with technician and/or equipment (i.e., workforce) availability. Moreover, this task is exacerbated by the inherently variable, sometimes unforeseeable nature of service-oriented workloads.

It is recognized that environmental conditions, such as humidity, precipitation, and temperature, as well as other ecological stresses, such as solar radiation and wind, degrade network resources, and thus, is correlated with increased trouble tickets—i.e., workload. In fact, the root-cause of many network failures, whether soft (i.e., performance degradation) or hard (i.e., total, or catastrophic system failure), is often attributable to weather related occurrences. Not surprisingly, network service providers generally receive an abrupt, if not extreme, increase in workload during weather episodes, such as during rainfall or relatively humid periods. Unfortunately, environmental conditions and their ultimate effect on an infrastructure are unpredictable, as well as geographically independent. That is, environmental stresses in one region are not necessarily the same as, or even comparable to, another region. Further, different regions of an infrastructure may be more or less vulnerable to certain types of ecological stresses based on the configuration of the infrastructure, i.e., exposure to the natural environment.

Traditionally, network service providers have attempted to manually balance their workload with their workforce using “on-the-fly,” intuition-based methods or other informal techniques, such as averaging the workload over a recent past to predict a narrow future. In other instances, service providers commit a workforce with the assumption that sufficient resources are, or at least will be, available. As such, the workforce and workload of the network service provider may be inefficiently and/or inconsistently managed, which becomes more acute when comparing the performance of one region to another. Further, such techniques lack an objective basis that can be dynamically assessed and improved upon. To remain competitive, however, network service providers must be able to provide consistent, high quality service across their footprint, as well as continually find new ways to predict a workload in order to more effectively and profitably locate and deploy a workforce. Therefore, the approach according to certain embodiments stems from the recognition that objective, dynamic workforce/workload modeling tools utilizing real-time information corresponding to the workforce, workload, and one or more factors affecting the workload (e.g., geographic locality, weather related phenomena, hypothetical inputs, etc.) provide an effective technique to systematically forecast, prioritize, and optimize the balancing between a workload and a workforce. Further, these tools enable network service providers to standardize their workforce/workload methodology across their footprint to facilitate the provisioning of consistent, high quality service despite regional variations.

As shown, system 100 includes modeling system 101 that is configured to forecast a current and/or a future workload based on information corresponding to a workforce, a current workload, historical workloads, and one or more factors influencing workloads, e.g., weather, geography, etc. According to one embodiment, modeling system 101 utilizes one or more real-time feeds of the aforementioned information to model and forecast a workload for a current date or over a specified future period of time, such as an afternoon, a day, a week, a month, a year, etc. In other instances, modeling system 101 may alert a workforce as to real-time variations in a workload that necessitate revisions to workforce scheduling. Furthermore, modeling system 101 may enable one or more users to review workforce performance (e.g., efficiency, proficiency, a number of incomplete jobs over a given period of time, etc.) to enable those users to conduct hypothetical workforce/workload modeling to facilitate workforce/workload decision making regarding future workforce performance. In order to implement various exemplary embodiments, modeling system 101 may execute one or more statistical prediction models, via prediction logic 105, which can dynamically adjust to the information corresponding to the workforce, the current workload, the historical workloads, and the one or more factors influencing workloads, e.g., weather, geography, etc. That is, modeling system 101 can utilize these prediction models to dynamically perform workforce/workload modeling to respond to the inherently variable, sometimes unforeseeable, nature of service-oriented environments. According to particular embodiments, the force/load modeling/forecasting may be performed macroscopically, i.e., as it pertains to a contiguous entity, or microscopically, i.e., from one region to another.

In this manner, modeling system 101 may be implemented in one or more computing environments, including as a backend component (e.g., as a data server), as a middleware component (e.g., as an application server), as a front-end component (e.g., as a client computing device having a graphical user interface (GUI) or web-browsing application through which the client computing device can interact with a data server or application server), or as any combination thereof Modeling system 100 may be interconnected by any form or medium capable of supporting data communication, such as one or more communication networks 107, e.g., a local area network (LAN), a metropolitan area network (MAN), a wide area network (WAN), the Internet, etc. Further, communication networks 107 may embody any telephony, packet-switched, or wireless network capable of transmitting data. As such, system 100 may embody a client-server environment, a master-slave environment, a peer-to-peer environment, or any other suitable environment.

Although depicted as separate entities, communication network(s) 107 may be completely or partially contained within service provider environment 103. For example, communication networks 107 may include facilities to provide for transport of packet-based and/or telephony communications within service provider environment 103. In an exemplary embodiment, service provider environment 103 may include the outside plant, the inside plant, and/or the inside wiring of a network service provider. By way of example, the outside plant includes the cables, conduits, ducts, poles, and other supporting structures, as well as certain equipment items, such as load coils, repeaters, etc., of a network service provider. Namely, the outside plant includes the local loops of the carrier, which are the physical connections from one or more customer premises (e.g., residential homes, commercial businesses, etc.) to the points of presence (POP) of the carrier. It is noted that the local loops may be provided over any suitable transmission medium, including twisted pair, fiber optic, coax, and the like. For example, a local loop of a conventional telephone system may comprise twisted pairs (or other wiring) that connect a demarcation point (e.g., a distribution frame, a cable head, etc.) of a customer premise to an edge (e.g., a circuit switch) of a local exchange carrier (LEC) central office (CO). The inside plant may include the fixtures, implements, machinery, and apparatuses used within one or more COs of the service provider, such as the switches, routers, broadband equipment, distribution frames, transmission equipment, power supply equipment, heat coil protectors, grounding systems, etc., of the network service provider. Accordingly, the inside wiring includes the aforementioned transmission mediums as those mediums are located within a customer premise or building. The inside wiring begins at the demarcation point and extends to individual end terminals, such as one or more client computing devices 109a-109n.

Service provider environment 103 may be, in one or more forms, naturally exposed to environmental conditions, as well as geographically dispersed across numerous regions or other logical divisions of a service provider environment 103. As such, modeling system 101 is configured to model, forecast, and balance a workload and a workforce as it pertains to maintaining, repairing, and extending service provider environment 103.

As shown in FIG. 1, modeling system 101 is implemented as a backend data server accessible to one or more client computing devices 109a-109n via a middleware application server, i.e., portal 111. Client computing devices 109a-109n interact with portal 111 via communication network(s) 107. According to one embodiment, portal 111 acts as an enterprise web portal that provides a consistent “look and feel” for access control and workforce/workload modeling. Such an architecture, while not necessary, enables client computing devices 109a-109n to be remotely dispersed (e.g., as by geography) from each other, as well as from modeling system 101, yet remain in collaboration with modeling system 101. Namely, portal 111 enables intelligent integration of and unified, real-time access to modeling system 101. According to one embodiment, portal 111 provides one or more customized portlets (e.g., user interface components) arranged in one or more page layouts, which can be tailored to the various users and/or logical divisions (e.g., geographical regions) of service provider environment 103. Thus, users of modeling system 101 can be provided a common set of web-based, or otherwise networked, workforce/workload modeling applications and resources to consistently and efficiently model, forecast, and balance workloads with workforces.

According to one embodiment, modeling system 101 also communicates with a ticket system 113, either directly or via one or more networks (such as a corporate network of the service provider), to obtain information regarding workloads. Tickets (e.g., trouble tickets) are utilized by carriers to document reported network problems and/or facilitate error detection notification. In other instances, tickets correspond to work orders, such as preventative maintenance procedures or provisioning new facilities or services to customers, e.g., installation of inside wiring at a customer's premise. As such, ticket system 113 is configured to accept reports from internal resources (e.g., technicians, system fault analyzers, etc.), as well as from external resources (e.g., customers) regarding network performance, maintenance procedures, or installation requests. This information may be utilized to generate one or more tickets. Alternatively, ticket system 113 may accept tickets generated by the internal or external resources and/or modifications thereto. In the aggregate, these tickets define the workload of a service provider. Thus, ticket system 113 is configured as an operations support system which provides modeling system 101 a unified view of the workload associated with service environment 103, however, ticket data may be segregated at any granularity to represent the workload as it corresponds to one or more geographic regions and/or time periods.

Ticket system 113 may be implemented as any suitable interface, such as a conventional call center, an interactive voice response (IVR) unit, a web-based graphical user interface (GUI), and/or any other equivalent interface, for generating and/or receiving tickets. For instance, a customer may initiate a communication session with an IVR implementation of ticket system 113 via a plain old telephone service device and provide verbal input concerning a problem or request of the customer, such as a loss of network connectivity or application for service installation. In response, ticket system 113 may generate an electronic record, i.e., a ticket, documenting the issue, as well as append to the record other information, such as customer and/or network demographic information. Ticket system 113 may also include a workflow engine that creates tickets based on network alarms, generated at, for instance, a real-time network monitor (not illustrated) that provides intelligent circuit and element testing data associated with fault detection and isolation. The real-time network monitor may further provide network topology information, real-time statistics, and intrusive test results. As such, ticket system 113 may include this additional information in a ticket. Further, ticket system 113 may also receive and/or track ticket status messages, such as a current stage of ticket investigation or ticket resolution, generated by a workforce management system 115, and include this information in a ticket.

Thus, by way of example, ticket system 113 can generate tickets including data, such as customer names, telephone numbers, addresses, narratives of the problems/work requests, hardware/software affected, related device addresses, fault analysis, network performance, real-time statistics, symptom codes, intrusive test results, severities, statuses, and/or any other suitable information, such as dates, times, reference numbers, related network topology information, etc. According to one embodiment, ticket system 113 structures and/or compartmentalizes this ticket information into fields, tables, or any other suitable data structure, such as a delimited text file. For example, a ticket data structure may include columns and rows that correspond to particular data fields and data entries, respectively. In any case, a data structure may be propagated with data entries corresponding to the ticket information for the purpose of workforce/workload modeling. Alternatively, data structures may be generated automatically. It is noted that the aforementioned data structures are merely exemplary and are not intended to limit the nature or structure of a data source that may be utilized by modeling system 101.

According to particular embodiments, ticket system 113 stores generated and/or received tickets at a repository 117, which may be utilized to store information regarding workloads corresponding to service provider environment 103. Additionally (or alternatively), tickets may be stored to a memory of ticket system 113 and/or transmitted to modeling system 101. As such, ticket system 113 also includes a communication interface (not shown) configured to transmit tickets, i.e., workload information, to modeling system 101, either “on-demand” or as the result of a predefined schedule, such as continuously or periodically, e.g., after a selected time period. Modeling system 101 may in turn include received ticket information (or parse tickets for particular information), which may then be ported into an application, data store, module, etc., such as a force/load analysis application of, for example, modeling system 101.

As a workforce is generally required to handle a workload, system 100 also includes workforce management system 115 in communication with modeling system 101, either directly or via one or more networks, such as a corporate network of the service provider. System 115 is configured to automate the management of maintenance, repair, and installation services that are performed in response to output from modeling system 101, as well as ticket system 113. The output may include particular tickets, i.e., a current workload, requiring resolution, as well as a forecasted workload based on one or more metrics including current/past workload information, workforce information, and one or more factors affecting workloads, e.g., weather, geography, etc. Further, workforce management system 115 is configured to push (either automatically or in response to a request) certain status information to modeling system 101 and/or ticket system 113 upon the occurrence of a status change to a ticket, workload schedule, etc. For example, a completed repair or installation order may warrant a status update message. As previously mentioned, this status information can be appended to one or more tickets. In turn, modeling system 101 may dynamically remodel or reforecast a workload based on this ticket information and/or status information provided by workforce management system 115.

According to certain embodiments, workforce management system 115 may also store corresponding workforce information at a repository 119. This information may be stored to a memory of workforce management system 115 and/or transmitted to modeling system 101. Workforce management system 115 includes a communication interface (not shown) configured to transmit workforce information to modeling system 101, either “on-demand” or as the result of a predefined schedule, such as continuously or periodically. Modeling system 101 may in turn include received workforce information (or parsed data for particular information), which may then be ported into an application, data store, module, etc., such as a force/load analysis application of, for example, modeling system 101.

The workforce information may correspond to one or more members of the workforce, and relate to member availability (e.g., scheduling information), skills, training, billing rate, assigned service provider environment 103 region, current geographic assignment, and employee/contractor status, as well as any other suitable workforce contingent parameter, such as work preferences, etc. Additionally, the workforce information may relate to repair equipment, transportation vehicles, and other workforce related resources. These various forms of workforce related information define the available workforce of a service provider. Thus, workforce management system 115 is configured as an operations support system which provides modeling system 101 a unified view of the workforce as it is associated with service environment 103.

Modeling system 101 models and forecasts a workload based on, for instance, one or more weather statistics, such as precipitation, relative humidity, etc. Accordingly, modeling system 101 may communicate with, either directly or via one or more networks, a weather statistics repository 121. In one embodiment, repository 121 is owned and operated by a third party, such as the National Weather Service. According to other embodiments, repository 121 is owned and operated by a network service provider. Repository 121 may include weather statistics, such as governing location, date, time, and forecast, including high/low temperatures and sky conditions, e.g., cloud cover, cloud deck, and precipitation. Other weather information can include relative humidity, wind velocity, wind gust, dew point, pressure, visibility, smog, air pollution, ultraviolet rating, ceiling, tide level, water/surf condition, etc., and may be stored within repository 121. This repository 121 can further store other pertinent information, such as meteorological, hydrological, climatological, and/or geophysical information. Modeling system 101 may receive suitable weather statistics film repository 121 to enhance a modeled/forecasted workload corresponding to service provider environment 103.

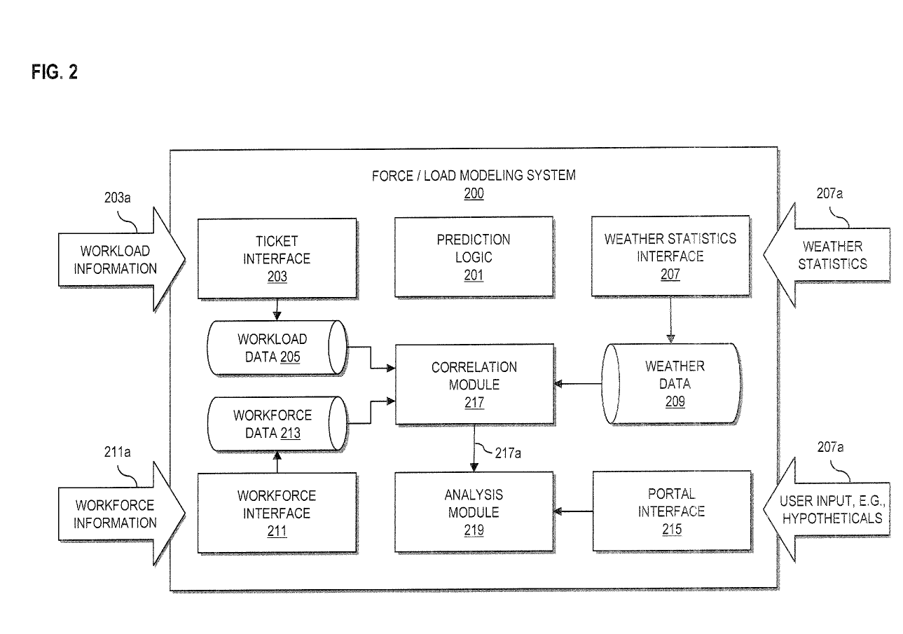

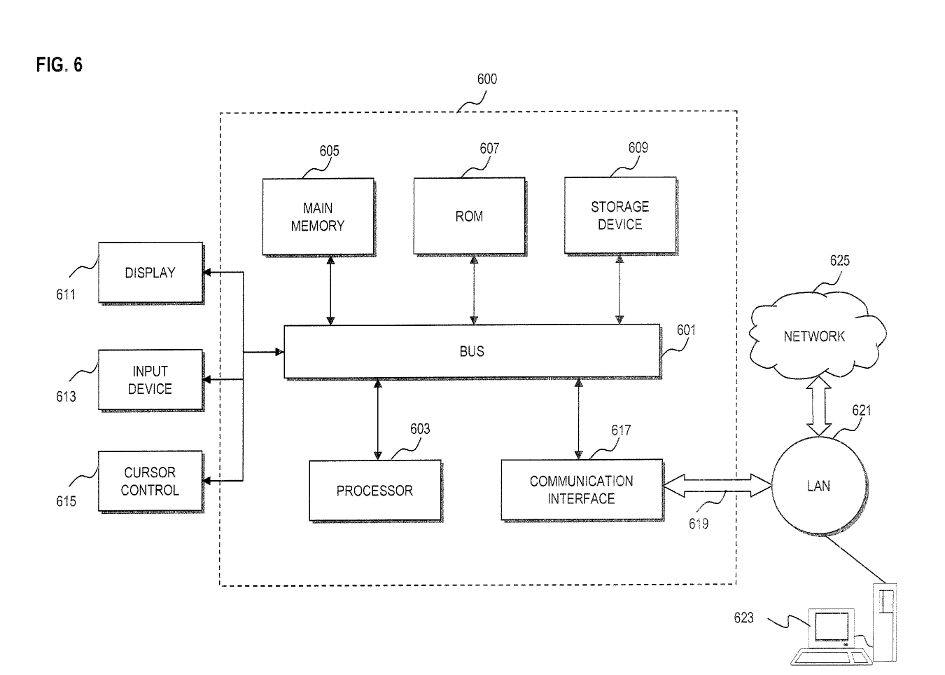

FIG. 2 is a diagram of a force/load modeling system, according to an exemplary embodiment. By way of example, force/load modeling system 200 may comprise computing hardware (such as described with respect to FIG. 6), as well as include components configured to execute the processes described herein. In an exemplary embodiment, modeling system 200 may be implemented as a rule-based system that utilizes rule-based business logic to obtain and analyze one or more metrics, such as a current workload, previous workloads, workforce information, and one or more factors affecting a workload (e.g., weather, geography, etc.) for modeling a current and/or future workload corresponding to a service-oriented environment, e.g., service provider environment 103. In other embodiments, modeling system 200 may utilize rule-based business logic to model a workload based on one or more hypothetical inputs corresponding to workforce productivity, workforce scheduling, and/or workload scheduling. Accordingly, modeling system 200 may also enable users to review workforce performance (e.g., efficiency, proficiency, a number of incomplete jobs over a given period of time, etc.) based on actual and/or hypothetical inputs.

As shown, modeling system 200 includes prediction logic 201, ticket interface 203, workload repository 205, weather statistics interface 207, weather repository 209, workforce interface 211, workforce repository 213, portal interface 215, correlation module 217, and analysis module 219. It is contemplated, however, that modeling system 200 may embody many forms and include multiple and/or alternative components. For example, it is contemplated that the one or more components of modeling system 200 may be combined, located in separate structures, and/or separate physical locations In other words, a specific data topology is not critical to embodiments of modeling system 200 or system 100.

Prediction logic 201 provides modeling, system 200 with one or more governing models utilized in the process of forecasting one or more workloads. These models may be developed based on regression of historical workload data as it pertains to one or more locations within service provider environment 103, such as a particular site, multiple localities, a geographic region, or any other suitable demographic population. In order to enhance forecasts, these models may also be based upon variable factors affecting workloads, such as weather related phenomena (e.g., precipitation and relative humidity) or substantially recent workload conditions, such as workload data corresponding to a previous window of time, e.g., the past few hours, the last couple of days, weeks, months, years, etc. According to certain other embodiments, a workload forecast can be made dependent upon the type of service provider environment 103 the workload corresponds to, such as a twisted pair, fiber optic, etc., environment. In various other embodiments, a workload forecast is made relationally proportional to the type of workload being forecasted, i.e., whether the workload corresponds to a residential workload, a business workload relating to repairing hard network failures, a business workload relating to repairing soft network failures, or a workload for provisioning new facilities/services. Additionally, the modeling and forecasting may be time sensitive. That is, prediction logic 201 may provide one or more models that can account for continuous or periodic forecasting intervals for each of the various environments and/or workloads, such as during an eight hour, twelve hour, eighteen hour, or twenty-four hour time interval; however, any such time interval or continuum is contemplated.

For the purposes of explanation, prediction logic 201 may provide two governing models for forecasting a workload. One model may correspond to maintenance or repair work and be termed “Maintenance Workload,” while the other model may correspond to provisioning or installation work and be termed “New Service Workload.” These models can be implemented according to the aforementioned service provider environments, the types of workload, the governing time periods, and related geographic regions. Namely, based on one or more of the these variables, one or more of the coefficients, and/or input data to the models, the “Maintenance Workload” or “New Service Workload” models can be controlled or selectively modified, as will become more readily apparent below. In this manner, Equation (1) corresponds to forecasting a “Maintenance Workload,” while Equation (2) corresponds to forecasting a “New Service Workload.” Equations (1) and (2) can be defined as follows:

$$\begin{matrix}n\_tkts {\_mw}_{fdh} = [ \begin{matrix}( 1 + {n\_tkts}_{{ }_{fd 1 \text{-} 7}} ) * ( {e}^{( V {1}_{fd} * C {1}_{f} + V {2}_{fd} * C {2}_{f} + … + V {7}_{fd} * C {7}_{f} )} ) * … * \\ ( {e}^{( V {8}_{fd} * C {8}_{f} )} ) * {( V {9}_{fd} )}^{C {9}_{f}} * {( V {10}_{fd} )}^{C {10}_{f}} * {( V {11}_{fd} )}^{C {11}_{f}} * … * \\ {( V {12}_{fd} )}^{C {12}_{f}} * {( V {13}_{fd} )}^{C {13}_{f}}\end{matrix} ] - 1 & Eq . ( 1 ) \\ n\_tkts {\_nsw}_{fdh} = [ \begin{matrix}( 1 + {n\_tkts}_{fd 1 \text{-} 7} ) * ( {e}^{( V {1}_{fd} * C {1}_{f} + V {2}_{fd} * C {2}_{f} + … + V {7}_{fd} * C {7}_{f} )} ) * … * \\ ( {e}^{( V {8}_{fd} * C {8}_{f} )} )\end{matrix} ] - 1 & Eq . ( 2 ) \\ where \text{:} & \\ V {1}_{fd} = \begin{matrix}1 , & if d is Sunday \\ 0 , & Otherwise\end{matrix} & Eq . ( 3 ) \\ V {2}_{fd} = \begin{matrix}1 , & If d is Monday \\ 0 , & Otherwise\end{matrix} & Eq . ( 4 ) \\ V {3}_{fd} = \begin{matrix}1 , & If d is Tuesday \\ 0 , & Otherwise\end{matrix} & Eq . ( 5 ) \\ V {4}_{fd} = \begin{matrix}1 , & If d is Wednesday \\ 0 , & Otherwise\end{matrix} & Eq . ( 6 ) \\ V {5}_{fd} = \begin{matrix}1 , & If d is Thursday \\ 0 , & Otherwise\end{matrix} & Eq . ( 7 ) \\ V {6}_{fd} = \begin{matrix}1 , & If d is Friday \\ 0 , & Otherwise\end{matrix} & Eq . ( 8 ) \\ V {7}_{fd} = \begin{matrix}1 , & if d is a Saturday \\ 0 , & Otherwise\end{matrix} & Eq . ( 9 ) \\ V {8}_{fd} = \begin{matrix}1 , & if d is a Holiday \\ 0 , & Otherwise\end{matrix} & Eq . ( 10 ) \\ V {9}_{fd} = \frac{1 + {pcp}_{fd}}{1 + {pcp}_{fd 1 \text{-} 7}} & Eq . ( 11 ) \\ V {10}_{fd} = \frac{1 + {pcp}_{- 1 fd}}{1 + {pcp}_{- 1 fd 1 \text{-} 7}} & Eq . ( 12 ) \\ V {11}_{fd} = \frac{1 + {rh}_{fd}}{1 + {rh}_{fd 1 \text{-} 7}} & Eq . ( 13 ) \\ V {12}_{fd} = \frac{1 + {rh}_{- 1 fd}}{1 + {rh}_{- 1 fd 1 \text{-} 7}} & Eq . ( 14 ) \\ V {13}_{fd} = \frac{1 + {tkts}_{B 4 Xfd}}{1 + {tkts}_{B 4 Xfd 1 \text{-} 7}} & Eq . ( 15 ) \\ where \text{:} & \\ \begin{matrix}n\_tkts {\_mw}_{fdh} = \begin{matrix}Predicted Number of Tickets Relating to a Maintenance \\ Workload for the {f}^{ th} Forecast Entity on the {d}^{ th} Day \\ Within the {h}^{th} Time Period\end{matrix} \\ n\_tkts {\_nsw}_{fdh} = \begin{matrix}Predicted Number of Tickets Relating to a New Service \\ Workload for the {f}^{ th} Forecast Entity on the {d}^{ th} Day \\ Within the {h}^{th} Time Period\end{matrix} \\ {n\_tkts}_{fd 1 \text{-} 7} = \begin{matrix}Average Number of Tickets for the {f}^{ th} Forecast Entity for \\ the Previous Seven Days\end{matrix} \\ {pcp}_{fd} = \begin{matrix}Amount of Precipitation for the {f}^{ th} Forecast Entity on the \\ {d}^{th} Day\end{matrix} \\ {pcp}_{fd 1 \text{-} 7} = \begin{matrix}Average Amount of Precipitation for the {f}^{ th} Forecast Entity \\ for the Previous Seven Days\end{matrix} \\ {pcp}_{- 1 fd} = \begin{matrix}Amount of Precipitation for the {f}^{ th} Forecast Entity for the \\ Previous Day\end{matrix} \\ {pcp}_{- 1 fd 1 \text{-} 7} = \begin{matrix}Average Amount of Precipitation for the {f}^{ th} Forecast Entity \\ Between Two Days Ago and Eight Days Ago\end{matrix} \\ {rh}_{fd} = \begin{matrix}Amount of Relative Humidity for the {f}^{ th} Forecast Entity on \\ the {d}^{th} Day\end{matrix} \\ {rh}_{fd1 \text{-} 7} = \begin{matrix}Average Amount of Relative Humidity for the {f}^{ th} Forecast \\ Entity for the Previous Seven Days\end{matrix} \\ {rh}_{- 1 fd} = \begin{matrix}Amount of Relative Humidity for the {f}^{ th} Forecast Entity for \\ the Previous Day\end{matrix} \\ {rh}_{- 1 fd 1 \text{-} 7} = \begin{matrix}Average Amount of Relative Humidity for the {f}^{ th} Forecast \\ Entity Between Two Days Ago and Eight Days Ago\end{matrix} \\ {tkts}_{B 4 Xfd} = \begin{matrix}Number of Tickets for the Time Period Before the {h}^{th} Time \\ Period\end{matrix} \\ {tkts}_{B 4 Xfd 1 \text{-} 7} = \begin{matrix}Average Number of Tickets for the Time Period Before the \\ {h}^{th} Time Period For the Previous Seven Days\end{matrix} \\ C {1}_{f , … ,} C {13}_{f} = \begin{matrix}Coefficients Having Values Dependent upon the {f}^{ th} Forecast \\ Entity , Which are Determined Through Regression of \\ Historical Workloads for the {f}^{ th} Forecast Entity\end{matrix} \\ f = \begin{matrix}Forecast Entity , i . e . , Geographic Region Within Service \\ Provider Environment 103\end{matrix} \\ d = \begin{matrix}Day of the Week , \\ Unless Day of Week is a Holiday , \\ Then Holiday\end{matrix} \\ {h}_{i} = \begin{matrix} Modeling \text{/} Forecasting Time Period ; \\ {h}_{1} = 0000 Hours \\ Utilized to Forecast Workload Over the \\ “ Next ” Twenty Four Hour Time Period \\ {h}_{2} = 0600 Hours \\ Utilized to Forecast Workload Between 0600 \\ Hours and 2400 Hours \\ {h}_{3} = 1200 hrs \\ Utilized to Forecast Workload Between 1200 \\ Hours and 2400 Hours \\ {h}_{4} = 1600 hrs \\ Utilized to Forecast Workload Between 1600 \\ Hours and 2400 Hours\end{matrix}\end{matrix} & \end{matrix}$$

As such, Equations (1) and (2) include both baseline (historical) and variable (dynamic) inputs, which enable the models to be objective and “self-correcting.” That is, a workload forecast, i.e., a predicted number of tickets for a given time period, is based on a moving average of a workload for the seven preceding days, as well as a workload for the preceding forecast period. Further, the models are similarly based on moving averages and preceding values corresponding to weather-related inputs (e.g., precipitation and relative humidity). Moreover, the models can be individually tailored, via the coefficients (which are obtained through historical data analysis of workload, workforce, weather, and geographic information), to forecast a workload for one or more locations (e.g., geographic regions) of service provider environment 103. In this manner, the models can adjust their basis according to regional differentiations, as well as adjust to long-term network changes, e.g., new service deployments, and short-term network changes, e.g., hard network failures. The forecasted workload outputs of Equations (1) and (2) may also may be combined with “leftover” workloads from previous days, as well as matched with current and/or anticipated workforce information (e.g., technician availability). This information may be utilized to review a current/expected workload to provision a current/expected workforce, as well as obtain information regarding workforce performance metrics (e.g., a number of current/expected incomplete jobs) based on a balancing of a workload to an availability of a workforce.

Accordingly, modeling system 200 includes ticket interface 203, weather statistics interface 207, and workforce interface 211 for obtaining (or receiving) workload information 203a (e.g., one or more tickets), weather statistics 207a, and workforce information 211a, respectively. Tickets corresponding to previous and/or current workload information 203a may be acquired from workload repository 117 via ticket system 113, while workforce information 211a may be acquired from workforce repository 119 via workforce management system 115. Weather statistics 207a can be acquired from weather statistics repository 121. In particular implementations, workload information 203a, weather statistics 207a, and workforce information 211a may be received in real-time, i.e., as generated, or in an “on-demand” fashion, e.g., after a predetermined time period, such as a preceding number of hours, days, months, years, etc. According to various embodiments, ticket interface 203, weather statistics interface 207, and/or workforce interface 211 parse workload information 203a, weather statistics 207a, and/or workforce information 211a, respectively, for select data fields and/or entries. For instance, tickets corresponding to workload information 203a may be parsed for a reporting date and time, as well as a reporting location (e.g., customer address) and work type (e.g., repair, provision, etc.). Weather statistics 207a may be parsed for select weather conditions (e.g., precipitation, relative humidity, etc.), as well as associated dates, times, and geographic locations. Further, workforce information 211a may be parsed for particular data, such as workforce availability, along with corresponding dates, times, and geographic locations. It is contemplated, however, that additional or alternative information may be parsed from workforce information 203a, weather statistics 207a, and/or workforce information 211a.

Any parsed information may be respectively stored in workload data repository 205, weather data repository 209, and workforce data repository 213. According to one embodiment, a single repository or a memory (not illustrated) of modeling system 200 may be provided for storing this information. Ticket interface 203, weather statistics interface 207, and/or workforce interface 211 may be configured to receive the parsed information directly from, for example, ticket system 113, weather statistics repository 121, and workforce management system 115, respectively. In particular embodiments, ticket interface 203, weather statistics interface 207, and/or workforce interface module 211 may comprise logical components of a communication interlace (not illustrated).

Furthermore, the data within repositories 205, 209, and/or 213 may be hierarchically arranged and queried for according to one or more commonalities, such as governing dates, times, and geographic locations, as well as any other suitable parameter. For instance, parsed workload and workforce information may be additionally arranged or queried for according to one or more commonalities corresponding to an environment type (e.g., twisted pair, fiber optic, etc.) and/or a workload/workforce type (e.g., residential, business relating to repairing hard network failures, business relating to repairing soft network failures, or provisioning new facilities/services).

Accordingly, correlation module 217 may be provided to extract and correlate data within repositories 205, 209, and 213. That is, correlation module 217 can be configured to retrieve suitable data within repositories 205, 209, and 213 according to one or more parameters, such as dates, times, geographic location, environment type, and/or workload/workforce type, in order to input corresponding parameters to analysis module 219 based on a forecast model being implemented by a user via a computing device, e.g., computing device 109a. For instance, obtaining workload information, workforce information, and/or weather statistics corresponding to a first region may be irrelevant to forecasting a workload for a second region. In this manner, correlation module 217 ensures relevant information is input to analysis module 219.

For the purposes of explanation, the aggregate output of correlation module 217 is referred to as data 217a. Thus, according to particular embodiments, correlation module 217 may port data 217a to a corresponding repository or memory (not illustrated), which is particularly useful in situations when modeling system 200 obtains (or receives) workload information 203a, workforce information 211a, and/or weather statistics 207a in real-time, but does not perform a workload forecast until after a predetermined time period, e.g., after a certain number of hours, days, months, years, etc., of information collection. Further, correlation module 217 may port data 217a to analysis module 219 for analysis, i.e., workload forecasting.

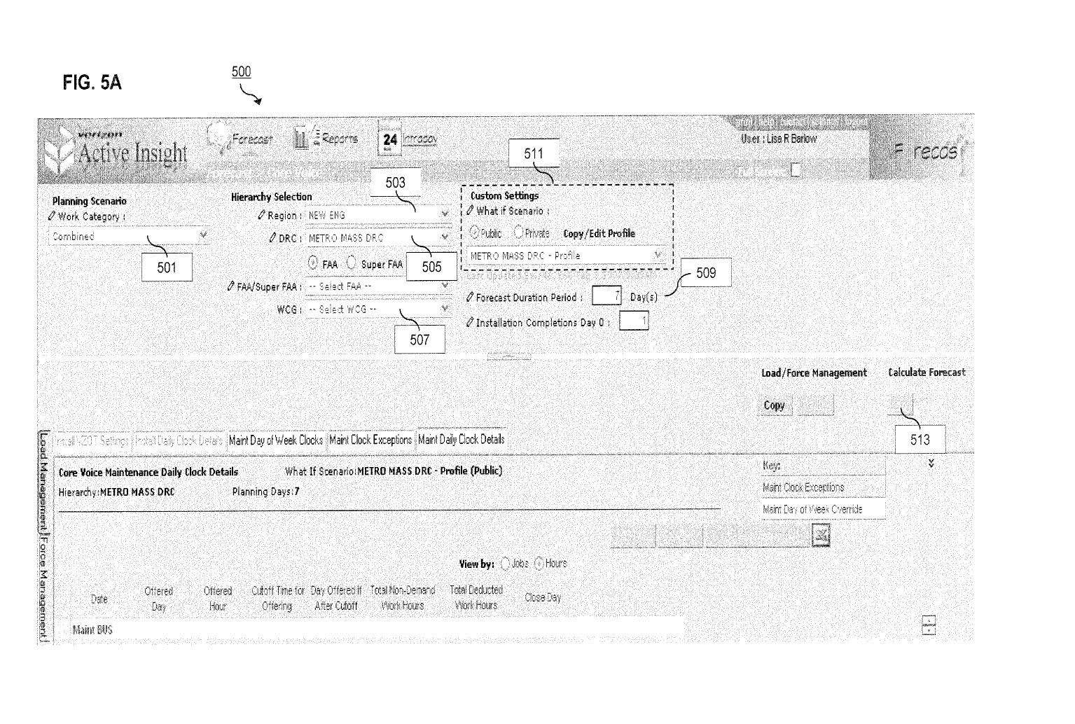

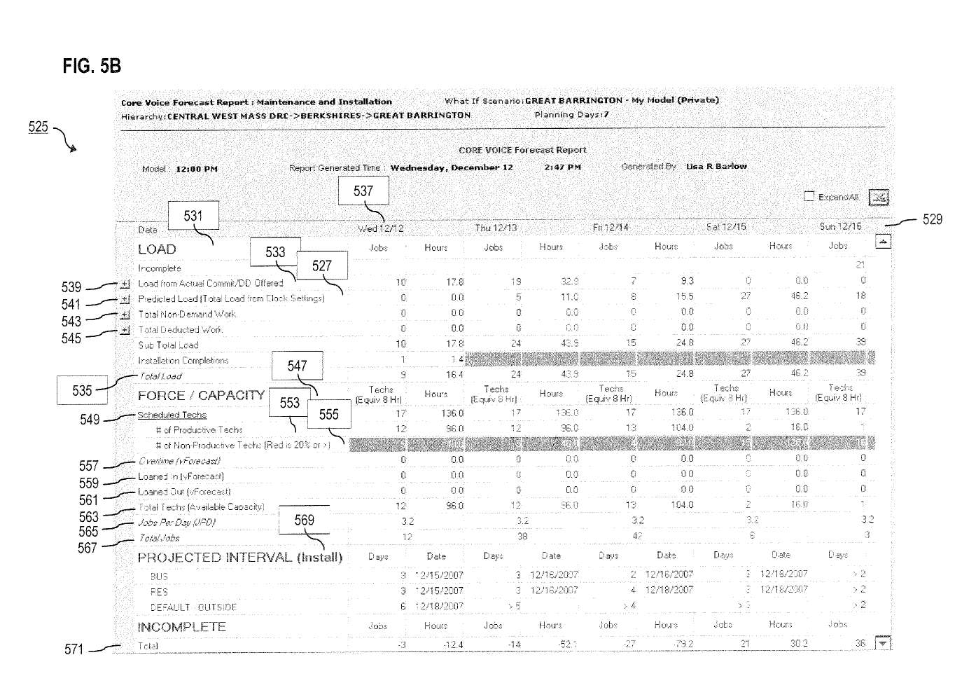

Analysis module 219 is configured to implement the prediction models established and defined within prediction logic 201. Namely, analysis module 219 performs workload forecasts on a per environment type, a per workload type, a per geographical region, and/or a per time interval/continuum basis. That is, analysis module 219 calculates a predicted number of tickets relating to maintenance and/or new service workloads for one or more service provider environments 103, one or more geographical locations/regions within service provider environments 103, over one or more predetermined time intervals, for one or more types of workloads via an “on-demand,” periodic, or continual basis. This information may be utilized to aggregate, schedule, and optimize a workforce to meet the forecasted workload demands. This information may be presented to a user at a client device, such as computing device 109a, via one or more portlets of portal 111. Exemplary portlets are described in more detail according to FIGS. 5A-5C.

In certain embodiments, analysis module 219 may also receive input from portal interface 215. Accordingly, analysis module 219 can receive user input, via a computing device (such as computing device 209a), relating to workload forecasting parameters, such as a governing service provider environment 103 type, a controlling geographic region of service provider environment 103, a workload type to forecast, and/or a forecast duration, i.e., time interval over which to forecast the workload, wherein these input parameters are utilized by analysis module 219 to obtain corresponding workforce information, workload information, and weather statistics from correlation module 217 or other component of modeling system 200. In essence, analysis module 219 provides an all-purpose control mechanism for acquiring appropriate data to forecast a workload in response to one or more user commands. As such, analysis module can invoke and/or respond to each of the other components of modeling system 200 as necessary to perform the various forecasting functions provided by modeling system 200. According to various other embodiments, the one or more components of modeling system 200 may operate autonomously with respect to analysis module 219.

Portal interface 215 can be configured to acquire user commands from a user at, for instance, computing device 109a. As such, portal interface 215 may execute a graphical user interface (GUI) application configured to provide the user with one or more menus of options relating to the aforementioned input parameters, which in turn, may invoke particular workload prediction models to be executed for forecasting one or more workloads on a per environment type, per geographic region, per workload type, and/or per time interval/continuum basis. This assists novice users who lack programming knowledge in performing queries and analyzing workforce, workload, and weather information, to obtain one or more forecasted workloads, which may be utilized to balance a corresponding workforce. In one embodiment, the GUI(s) are presented in one or more windows or portlets of a conventional browser application. According to certain embodiments, the GUI(s) may be generated and presented in one or more windows or portlets controlled by a client computing device, such as computing device 109a. These GUIs or portlets may comprise pages of both textual and graphical information, as well as various interactive control widgets, through which users may access and interact with analysis module 219. Thus, users at computing device 109a may input commands to specify the input parameters to obtain corresponding workload forecasts.

According to certain embodiments, portal interface 215 also enables users to review workforce performance (e.g., efficiency, proficiency, a number of incomplete jobs over a given period of time, etc.) to enable those users to conduct hypothetical workforce/workload modeling to facilitate workforce/workload decision making regarding future workforce performance. In this manner, a user may input hypothetical workload/workforce parameters for generating hypothetical workload forecasts. These hypothetical inputs may correspond to information regarding workforce productivity (e.g., the workforce may complete “x” number of jobs in “y” amount of time), workforce scheduling (e.g., availability parameters of current and/or contemplated workforce members, such as days, times, etc.), and/or workload scheduling (e.g., work orders promised by time “z2” instead of “z1”), as well as any other suitable parameter. Analysis module 219 may utilize these hypothetical inputs to remodel or reforecast a hypothetical workload, which may be utilized for workforce decision making, e.g., whether to loan in employees from neighboring garages, whether to hire new employees/contractors, whether to conduct training programs, whether to let other employees/contractors go, etc. In this manner, portal interface 215 may also comprise a logical component of a communication interface (not illustrated) of modeling system 200.

While not illustrated, modeling system 200 may also include an authorization module for authenticating users to modeling system 200 via portal 111. That is, the authorization module may verify user log on data (e.g., credential information, such as a username and password) against an authorized user list including corresponding information in, for example, a memory (not illustrated) of modeling system 200 or other repository of systems 100 or 200 to provide selective access to the functions of modeling system 200. In various embodiments, information stored to a user profile may be utilized by the authorization module to permit or restrict access to select workload forecasting models, such as limiting users to particular environment types, workload types, geographic regions, and/or forecasting time intervals/ continuums.

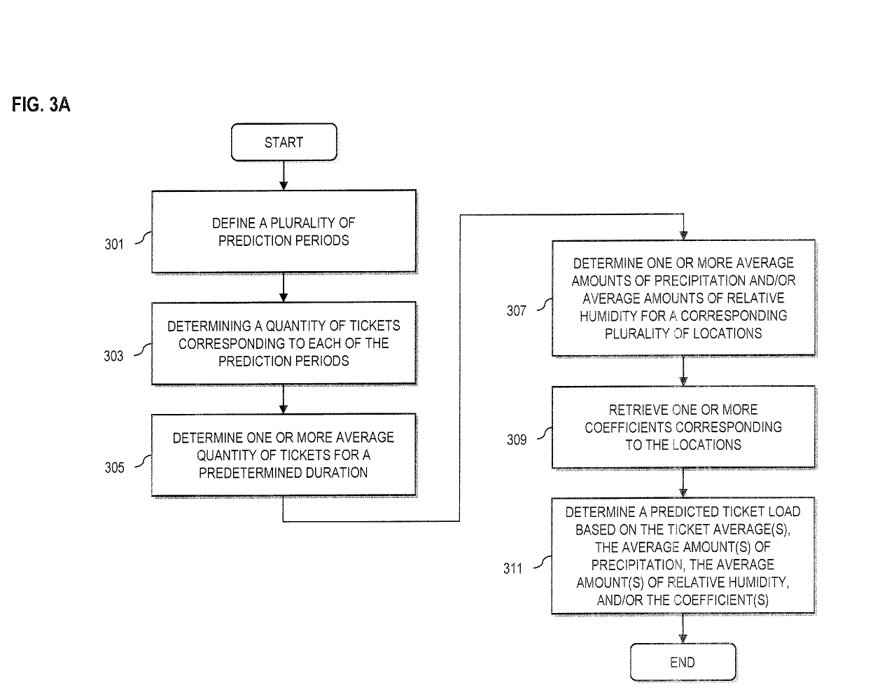

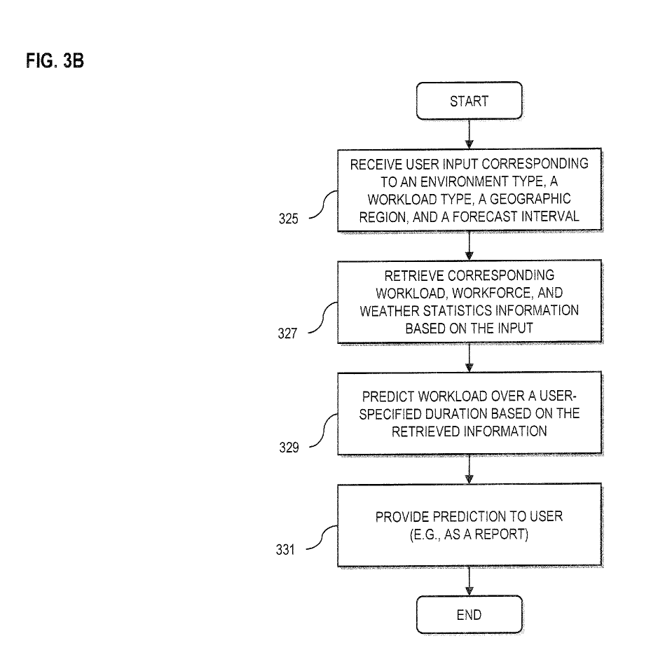

FIG. 3A is a flowchart of a process for forecasting a workload, according to an exemplary embodiment. For the purposes of explanation, a forecasted workload is defined in terms of a predicted amount of tickets, i.e., jobs, generated or in existence at a given period of time within a time interval being forecasted, such as the next hour, the current day, week, month, year, etc., according to the model defined by Eq. (1)-(15). In this manner, multiple prediction periods can be defined, per step 301. For instance, if the workload is being forecasted for any given day (or twenty-four hour time period), then the day may be divided into a plurality of forecasting periods, such as six, four hour time divisions, which enables smaller prediction windows that can be aggregated to better approximate a whole. Namely, as the prediction periods are made smaller, a “current” workload prediction may dynamically adapt to real-time conditions to increase the accuracy of the predictions. For practical purposes, the prediction periods can also be made to correspond to workforce scheduling periods, such that the time scheduling of a workforce can be made to correspond to the time sensitive nature of the workload.

At step 303, a quantity of tickets corresponding to each of the prediction periods may be determined for a predetermined duration of historical time. For example, the determined quantities may correspond to quantities of tickets for the hours, days, weeks, months, years, etc., previous to the period of time being forecasted. According to one embodiment, the quantities are determined for each of the prediction periods for the previous 168-hour time period. In step 305, an average quantity of tickets for each prediction period over the predetermined duration of historical time is determined. For instance, if the prediction periods correspond to six hour time divisions of a twenty four hour time period, then for each corresponding six hour period of time within, for example, the past 168 hours, an average quantity of tickets is determined, such that four corresponding ticket averages can be generated.

For a particular geographic region (i.e., the plurality of locations corresponding to the geospatial area that the tickets relate to), one or more average amounts of precipitation and/or average amounts of relative humidity may be determined for a predetermined duration of time, per step 307. According to one embodiment, the average amounts of precipitation and the average amounts of relative humidity may be determined for each twenty four hour time interval within a previous 192 hour period of time, i.e., resulting in eight averages. Additionally, one or more aggregate averages of the precipitation and relative humidity may be determined. For example, and assuming a time interval extending from hour “0” to hour “192,” aggregate averages of the precipitation and relative humidity may be determined for the time intervals characterized by hour “0” to hour “168” and hour “24” to hour 192.” At step 309, one or more coefficients corresponding to the geographic region may be retrieved for their use to estimate a predicted amount of tickets. These coefficients may be generated based on regression of historical ticket loads over a predetermined time period for the geographic region, such the past day, week, month, year, etc. Accordingly, at step 311, a predicted ticket load may be determined for each of the plurality of prediction periods based on the one or more ticket averages, the one or more average amounts of precipitation, the one or more average amounts of relative humidity, the one or more aggregate averages, and/or the one or more coefficients. The predicted ticket loads may be further aggregated, such as for determining an aggregate predicted ticket load for one or more twenty four hour time periods.

This process may be iteratively implemented, such that a workload may be determined for any forecast time period. Accordingly, each of the time based determinations will “move” with time period being forecasted. As such, one or more “previous” prediction iterations may be utilized to determine a “next” iteration. Furthermore, forecasted weather related information (i.e., forecasted precipitation and relative humidity) may be utilized. As such, it is contemplated that the ticket load predictions may be dynamically processed, wherein previous ticket load predictions based on predicted ticket loads and/or forecasted weather related information may be dynamically re-predicted with “actual” data.

FIG. 3B is a flowchart of a process for providing a workload model, according to an exemplary embodiment. This process is described with respect to the exemplary user interfaces of FIGS. 5A and 5B. Initially, one or more workload forecast models are generated based on regression of historical workforce, workload, and weather statistics information stored in, for example, repositories 117, 119, and 121, respectively. According to one embodiment, the historical information corresponds to one or more service provider environment types, one or more geographic regions, one or more workload types, and one or more time durations. In particular implementations, the historical information may date back over an extended time period, such as a year, five years, ten years, etc. Accordingly, one or more forecasting models may be established and periodically updated through an “off-line” routine, wherein the historical information is analyzed to formulate the one or more forecasting models, such as the aforementioned models described with respect to Equations (1) and (2), as well as the one or more coefficients, e.g., coefficients C1_{f} through C13_{f}, made dependent upon the one or more service provider environment types, the one or more geographic regions, the one or more workload types, and/or the one or more time durations. These models can be stored as part of prediction logic 201.

In this manner, a user may access modeling system 200, via portal 111, by way of a computing device (e.g., computing device 109a), which is capable of processing and transmitting data over one or more networks (e.g., communication networks 107). That is, the user may interact with an input interface of computing device 109a to activate software resident on the device, e.g., a browser application. The software may then establish one or more connections to portal 111, via communication network 107, through, for example, an internet protocol (IP) based connection. Portal 111 may provide the user one or more portlets for accessing the features of modeling system 200; however, before granting this access, the user may be required to provide certain credentials, such as a username and password, to portal 111 via, for instance, a GUI of the browser application. According to one embodiment, user “log on” procedures may be facilitated by the aforementioned authentication module of modeling system 200, which may access corresponding user credential information to authenticate the user. It is contemplated, however, that additional or other credential information may be utilized. For instance, authentication procedures may be based upon an IP address and digital signature of an accessing computing device 109a, etc.

Once the user is successfully authenticated, portal 111 grants the user access to the workforce/workload modeling features of modeling system 200. According to one embodiment, portlet applications may be individualized to authorized users, such that one or more command options may be tailored to the environment and region that the user oversees. Namely, the browser application displays information acquired from portal 111 to the user via a display interface of computing device 109a. The command options may correspond to selections for specifying an environment type, a workload type, a geographic region, a particular facility within that region, and/or a workload forecast duration period for forecasting a workload, as well as any other suitable parameter, such as custom setting input fields for hypothetical workload forecasting.

As seen in FIG. 5A, GUI 500 provides a plurality of “drop-down” menus and input fields to enable individual users to specify, a workload type (menu 501), a geographic region (menus 503 and 505), a particular facility within that region (menu 507), and/or a workload forecast duration period (input field 509) for forecasting a workload, as well as one or more custom settings options 511 for providing hypothetical forecasting inputs. While not illustrated, a menu may also be provided for user to specify a government service provider environment type. It is noted that the “selection” of one option within a first menu may dynamically modify the availability of other options in other menus. For instance, if a user selects to forecast a workload corresponding to a particular region within menus 503 and 505, the particular facilities within menu 507 may be dynamically updated to correspond to this region. Nevertheless, by manipulating and interacting with the menus, a user may seamlessly obtain a desired workload forecast, which may be utilized for balancing a corresponding workforce.

Referring now to FIG. 3B, at step 325, modeling system 200, via portal interface 215, receives user input corresponding to an environment type, a workload type, a geographic region, a particular facility within that region, and/or a workload forecast duration period for forecasting a workload. This input is based on the user selecting, or otherwise interacting with, corresponding menus 501-507 and input field 509. The input may be transmitted to modeling system 200 in response to the user interacting with icon 513 of FIG. 5A, i.e., a “CALCULATE FORECAST” icon. According to other embodiments, the inputs mi-ay be provided to modeling system 200 as selected/generated by the user. Based on the received input, modeling system 200 retrieves corresponding workload, workforce, and weather statistics information via interfaces 203, 211, and 207, respectively, per step 327. The information may be drawn from repositories 117, 121, and 119, respectively. As such, interfaces 203, 207, and 211 may, as required, parse the received information for corresponding parameters associated with the user-provided inputs, such as workload, workforce, and weather statistics related to the specified environment type, workload type, geographic region, and/or particular facility. According to other embodiments, this information may be directly provided to modeling system 200 or may have been previously provided via a real-time or periodic information feed, in which case, the various information feeds may have been parsed such that the pertinent data was previously and/or hierarchically stored to repositories 205, 209, and 213, wherein the necessary information may be drawn from these repositories 205, 213, and 209, via correlation module 217 based on the user input.

At step 329, correlation module 217 provides one or more forecasting inputs, e.g., data 217a, to analysis module 219 so that analysis module 219 may forecast, or otherwise predict, a workload over the user specified forecasting duration. Analysis module 219 utilizes corresponding prediction models and model coefficients provided by prediction logic 201. Per step 331, analysis module 219 provides the workload forecast to portal interface 215, which provides presentation information to portal 111 for display of the forecasted workload via a display interface of computing device 109a.

As seen in FIG. 5B, the forecasted workload may be presented as report 525, which conveys a predicted number of tickets and corresponding number of work hours related to those tickets (i.e., row 527) on each day (e.g., day 529) of the forecast period within report portion 531. According to one embodiment, these predictions may be additionally segregated according to one or more time intervals (e.g., per hour increments) of the forecast days/period. The predicted number of tickets may also be combined with projected “carry over” jobs and committed actual load, i.e., row 531. Rows 527 and 529 may be summed within row 535 representing a total workload and total corresponding work time for each day of the forecast period. For example, on Wednesday (day 537) the workload is characterized by nine tickets corresponding to approximately sixteen and a half hours of work. Selectable icons 539-545 may be utilized (i.e., interacted with) to ascertain the distribution of tickets and hours (i.e., workload) as they relate to the one or more workload types, i.e., residential, business, etc.

Report 525 may also provide workforce information within region 547, which may provide information regarding a number of available workforce members and corresponding available working time within row 549. Rows 551 may be provided to “characterize” the workforce as it relates to information, such as a number of active workers (row 553) and inactive workers (row 555), as well as other characterizations like overtime workers (row 557), contractors working for the workforce (row 559), contractors being loaded from the workforce (row 561), total available worker capacity (row 563), a workforce efficiency, such as jobs per day, (row 565), and a total amount of assigned jobs (row 567). Region 569 may provide new facility/service provisioning (e.g., installation work) as it relates to business and residential customers, and a scheduled date for completing the job. Furthermore, based on the workforce information and the workload information, the display may also include an actual or expected number of incomplete jobs (row 571) for each of the forecasted time periods (e.g., days). Utilizing this information, a workforce administrator may entertain strategic workforce decisions to balance a workforce to the forecasted workload.

According to one embodiment, report 525 is a dynamic report. That is, users may modify one or more entries, which cause other entries to be re-determined, i.e., re-forecasted. Essentially, users may modify the fields to facilitate workforce and workload balancing, as well as other managerial decisions, thereby conducting “hypothetical” or “what if” scenarios.

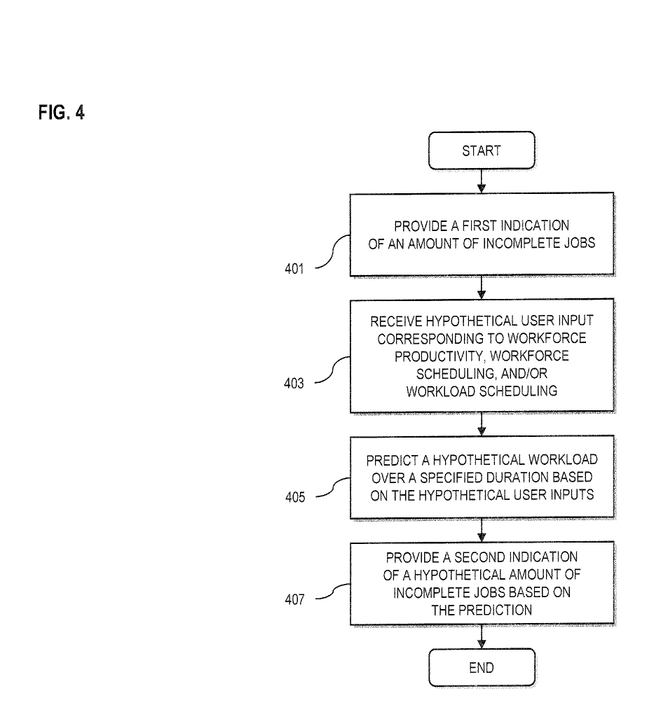

FIG. 4 is a flowchart of a process for providing a hypothetical workload based on one or more hypothetical user input parameters, according to an exemplary embodiment. In step 401, modeling system 200 provides a user a first indication of an amount or expected amount of incomplete jobs based on actual and/or forecasted workload/workforce information. Accordingly, a user may, via the one or more fields of report 525, input one or more hypothetical workforce/workload parameters to perform a hypothetical workload forecast to facilitate workforce decision making. These parameters may correspond to information regarding workforce productivity (e.g., the workforce may complete “x” number of jobs in “y” amount of time), workforce scheduling (e.g., hypothetical availability parameters of a current and/or contemplated workforce members, such as days, times, contactors, overtime, etc.), and/or workload scheduling (e.g., work orders promised by time “z2,” instead of time “z1”), as well as any other suitable parameter. These hypothetical user inputs are provided to modeling system 200, namely analysis module 219, via portal interface 215, per step 403. Based on these additional inputs, analysis module 219 may reforecast the workload. Utilizing these additional hypothetical inputs, however, analysis module 219 may recalculate a current and/or expected number of incomplete jobs, per step 405. In step 407, modeling system 200 provides a second indication of a hypothetical amount or hypothetical expected amount of incomplete jobs based on the hypothetical inputs. This information may be provided to the user via portal interface 215, in conjunction with a display interface of a computing device, e.g., computing device 109a. As such, a user may iteratively conduct hypothetical scenarios to determine an optimum workforce for an actual or forecasted workload. According to other embodiments, analysis module 219 may iteratively determine an optimum workforce based on an actual and/or forecasted workload and provide this information to the user along with the actual and/or forecasted workload.

The processes described herein for workforce and workload modeling may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 6 illustrates computing hardware (e.g., computer system) 600 upon which an embodiment according to the invention can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The tern “computer-readable medium” as used herein refers to any medium that participates in providing instructions to the processor 603 for execution. Such a medium may take many forms, including but not limited to nonvolatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting a portal configured to receive input from a user, wherein the input relates to forecasting workload and workforce for providing a communication service, the workload including ticket loads relating to repair and provisioning, the workforce including human resources and equipment; and
outputting a load prediction in response to the input, wherein the load prediction is generated by a forecast model that utilizes regression analysis of historical data and real-time information that includes workforce availability data and one or more factors impacting the workload.

2. A method according to claim 1, wherein the factors include weather information, the method further comprising:
detecting a change in one of the factors; and
generating a notification to the user to update the load prediction based on the change.

3. A method according to claim 1, further comprising:
notifying the user that the load prediction results in a particular quantity of incomplete jobs.

4. A method according to claim 1, further comprising:
receiving another input from the user, wherein the input specifies one or more of the factors including workload interval, workforce capacity, workforce productivity, or a combination thereof; and
modifying the load prediction in response to the other input.

5. A method according to claim 1, wherein the portal provides a collection point for the real-time information from a plurality of third party data sources.

6. A method according to claim 1, wherein the load prediction is self-correcting based on a moving average of prior load predictions.

7. A method according to claim 1, further comprising:
periodically retrieving new real-time information, wherein the load prediction is updated in response to new real-time information

8. An apparatus comprising:
a communication interface configured to present a portal configured to receive input from a user, wherein the input relates to forecasting workload and workforce for providing a communication service, the workload including ticket loads relating to repair and provisioning, the workforce including hum an resources and equipment; and
a processor configured to output a load prediction in response to the input, wherein the load prediction is generated by a forecast model that utilizes regression analysis of historical data and real-time information that includes workforce availability data and one or more factors impacting the workload.

9. An apparatus according to claim 8, wherein the factors include weather information, the processor is further configured to detect a change in one of the factors, and to generate a notification to the user to update the load prediction based on the change.

10. An apparatus according to claim 8, wherein the processor is further configured to notify the user that the load prediction results in a particular quantity of incomplete jobs.

11. An apparatus according to claim 8, wherein the portal is further configured to receive another input from the user, the input specifying one or more of the factors including workload interval, workforce capacity, workforce productivity, or a combination thereof, the processor being further configured to modify the load prediction in response to the other input.

12. An apparatus according to claim 8, wherein the portal provides a collection point for the real-time information from a plurality of third party data sources.

13. An apparatus according to claim 8, wherein the load prediction is self-correcting based on a moving average of prior load predictions.

14. An apparatus according to claim 8, wherein new real-time information is periodically retrieved, and the load prediction is updated in response to new real-time information.

15. A computer-implemented method comprising:
defining a plurality of prediction periods;
determining a quantity of tickets corresponding to each of the prediction periods;
computing an average for the tickets for a predetermined duration;
determining average amount of precipitation, or average amount of relative humidity, or a combination thereof, for a corresponding plurality of locations;
retrieving coefficients corresponding to the locations, wherein the coefficients indicate degree of influence of weather condition or prior load for the respective locations; and
outputting a predicted ticket load based on the ticket average, the average amount of precipitation, the average amount of relative humidity, and the coefficients.

16. A method according to claim 15, wherein data about the precipitation and the relative humidity are retrieved in real-time.

17. A method according to claim 15, further comprising:
receiving workforce information; and
determining quantity of incomplete jobs based on the workforce information and the predicted ticket load.

18. A method according to claim 15, wherein the predicted ticket load is based on a moving average of prior predictions of the ticket loads.

19. A method according to claim 15, further comprising:
receiving a user command from a browser; and
updating the predicted ticket load in response to the user command.

20. A method according to claim 15, wherein the predicted ticket load relates to repair of a communications equipment or provisioning of a communication service.
